(19) United States
(12) Patent Application Publication
(10) Pub. No.: US 2003/0081759 A1
(43) Pub. Date: May 1, 2003

(54) User selectable power cutback for off-hook events

(75) Inventor: G. Kate Harris, Ottawa (CA)

Correspondence Address: OGILVY RENAULT, 1981 MCGILL COLLEGE AVENUE, SUITE 1600, MONTREAL, QC, H3A2Y3, CA

(73) Assignee: Nortel Networks Limited

(21) Appl. No.: 09/742,317

(22) Filed: Dec. 22, 2000

(51) Int. Cl. H04M 9/00; H04M 7/00; H04M 1/76

(52) U.S. Cl. 379/395.01; 379/399.01; 379/416

(57) ABSTRACT

In a splitterless xDSL communications services set-up providing data and voice services to co-connected equipment, data signals may cause audible interference in POTs handsets. The degree of the interference varies widely due to a wide variation of customer tolerance and of susceptibility of the handsets. Reducing data channel transmission power during an off-hook event may reduce interference. A method and system are provided for user adjusted cutback. While making a POTs call, data channel power may be adjusted until acceptable performance is obtained. The customer selected power cutback influences both ATU-R and ATU-C transmit levels.

### CROSS-REFERENCE TO RELATED APPLICATIONS

This is the first application filed for the present invention.

### MICROFICHE APPENDIX

Not applicable.

### TECHNICAL FIELD

The present invention relates to Digital Subscriber Line (DSL) communications services and, in particular, to controlling data channel transmission power of a communications device during off-hook events of a co-connected telephone handset.

### BACKGROUND OF THE INVENTION

Digital Subscriber Line (DSL) communications services encompass a variety of technologies designed to operate over conventional copper (twisted pair) subscriber loop connections previously installed to provide Plain Old Telephone Service (POTs) . ADSL services (e.g. ADSL and ADSL.Lite) which co-exist with POTs employ advanced modulation techniques to take advantage of a frequency spectrum that is not utilized by POTs transmissions on the subscriber loops. Standard voice calls utilize a spectrum between 0-4 kHz, while ADSL and ADSL.Lite utilize frequencies between 26 kHz and 1 MHz and thus can transmit data at high data rates concurrently with POTs transmissions. Accordingly, the communications service delivered to the subscriber is divided into a (low frequency) POTs channel, and a (high frequency) Data channel, both of which can operate concurrently.

In order to provide XDSL services, specialized equipment must be installed at both ends of the subscriber loop. At the subscriber's site, customer premise equipment (CPE) comprising a communications device (e.g. a modem) with a built-in Network Interface Card (NIC) is required. At the Central Office (CO), one or more line cards are typically used to handle the data channel traffic and the POTs channel traffic.

At the subscriber's premises (for example a private residence, or small business), it is common practice to connect various CPE communications devices (e.g. fax equipment, POTs handsets, and voice frequency modems) to the same subscriber loop. In such situations, it is likely that a communications device will be connected to a subscriber loop having one or more co-connected POTs handsets. Although the data channel operates well above normally audible frequencies, it is known that data channel traffic can cause audible interference in a POTs handset during simultaneous data and POTs sessions. The extent to which the interference creates a problem varies widely due to a wide range of POTs handset technology and customer tolerance. Some POTs handsets generate audible noise because circuits within the handset are overloaded by the data channel signal. Other POTs handsets may effectively screen-out the data channel signal and generate little or no audible interference. The amount of noise generated is known to relate to the design of the POTS device. Additionally, some subscribers place a lower priority on the quality of voice-channel communications, and are thus more tolerant of audible interference than others.

Conventionally, the problem of audible interference has been addressed by means of splitters or filters, which de-couple POTs and data channel traffic. Splitters represent an optimal solution but the installation of a splitter must be done by a skilled technician, and also requires rewiring of the customer premise. Consequently, a vehicle must be dispatched and a technician sent to the customer premises to install the splitter. This is expensive and time consuming, both of which are often unacceptable to the customer. With respect to filters, U.S. Pat. No. 5,848,150 (Bingel) teaches a passive distributed filter systems, in which each POTs handset is connected to the subscriber loop via a passive in-line low-pass filter. The low-pass filter attenuates the high frequency data channel signal, so that audible interference in a filter-protected POTs handset is reduced. While the use of filters in this manner can be useful, it involves a number of disadvantages. First, a separate filter must be purchased and installed for each POTs handset that is to be connected to the subscriber loop. This adds costs and inconvenience for the subscriber. Consider, for example, wall-mounted POTs handsets having little or no room between the handset and an in-wall connection jack to which the handset is connected. No space exists within which to add a splitter/filter. If the subscriber relocates their POTs handset, they must also relocate the filter, which is also inconvenient. Some filters are unidirectional, and thus must be installed correctly in order to function. Furthermore, some filters introduce interference into the access loop by altering the line impedance and may thus impair audio performance and/or degrade the data channel traffic performance. Furthermore, the number of handsets requiring filters must also be considered. As the number of filters connected in parallel increases, the POTs signal tends to degrade. When the number of handsets is large, voice quality may be unacceptably affected. At any rate, the protection provided by inline filters may not necessarily provide adequate protection for all POTS devices.

Another method of reducing audible interference is to attenuate (or cut back) data channel transmission power from the communication device. It: is known that power attenuation is useful for reducing audio interference and the impact of non-linear distortions (which can cause up-stream data traffic to interfere with down-stream data traffic) often created by an off-hook POTs handset in splitterless installations. Conventionally, in ADSL.Lite when an off-hook event is detected, a “fast retrain” occurs which may include a line-probe at the CPE to measure interference. Based on the measured interference, the CPE can then determine appropriate cutbacks for both the CPE and the CO. The CPE then messages both cutbacks to the CO. Since the line probe is performed at the CPE end of the subscriber loop, a transmission power level determined in this manner effectively deals with the effects of non-linear distortions introduced by the off-hook POTs handset. However, there is no linear relationship between audio interference and data channel transmit power of the communication device. Consequently, the line probe does not necessarily provide useful information for predicting audio interference.

To address a non-linearity on the subscriber loop that may cause in-band distortions severe enough to reduce data throughput beyond that achievable with lower transmit power levels, a CPE line probe can be conducted at start-up or fast retraining to identify such distortions. Often the cause of such distortions is an off-hook POTs handset. Some POTs handsets may cause this problem in the on-hook state as well. The distortions can be measured in the down-stream band by the CPE receiver using a CPE transmission probe in the up-stream band and a suitable corresponding power cutback can be calculated. However, audible distortion at the handset may not be measurable by line probe testing.

Another way of addressing this problem is to set a factory default value for the power reduction in an effort to control audible interference while off-hook. However, reducing the data channel transmission power usually has a negative effect on the data transmission rate. Furthermore, as noted above, subscribers have different POTs devices (with varying degrees of susceptibility to audio interference), and varying degrees of tolerance to audio interference. Accordingly, if the factory default power cutback is too large, the subscriber will experience a degradation in data transmission performance, with little benefit. Alternatively, if the factory default cutback is too small, the subscriber may still experience unacceptable audio interference.

Consequently, there exists a need for a mechanism that permits a customer to control a data channel transmission power level of a CPE communications device, to permit the customer to adjust POTS audio quality to suit a personal preference.

### SUMMARY OF THE INVENTION

It is an object of the invention to provide a method and apparatus for selecting a data channel transmission power cutback of a communication device that permits a customer to balance data performance and POTs audio quality to suit a personal preference.

Accordingly, an aspect of the present invention provides a method of regulating data channel transmission power of a data communication device during off-hook events of a co-connected POTs handset. The method includes steps of determining a value of at least one user control indicators indicative of user-discernible performance qualities. A data channel transmission power level is calculated using the value of at least one user control indicator. The calculated power level is stored in a memory of the communication device, and the data channel transmission power is set in response to the calculated power level during each off-hook event. Preferably, the step of calculating comprises calculating an upstream power reduction value and a downstream power reduction value and the step of setting includes a step of signaling the downstream power reduction value to a central office with which the data communications device is in communication. Furthermore, the method preferably includes a step of determining a default off-hook power level, and the step of calculating uses the default off-hook power level as an input. The user-discernible performance qualities include at least one of: data transmission speed of the communication device; audible interference in the POTs channel handset; and, a user prioritization between data channel and POTs channel performance.

Another aspect of the present invention provides a method of controlling audible interference in a POTs channel handset induced by data channel transmission power of a co-connected xDSL communications device. The method comprises the steps of defining at least one user-selectable attribute indicative of at least one user-discernible performance quality. The at least one attribute is monitored for a change in state and a level of data transmission power is calculated on the basis of the at least one attribute. The calculated power level is stored in a memory of the communication device; and during an off-hook event of the POTs handset, the data channel transmission power of the communications device is controlled in accordance with the stored power level.

In accordance with a further aspect of the invention, there is provided a computer program for a XDSL communications device for controlling audible interference in co-connected POTs handsets.

In an embodiment of the invention, the user discernible attributes include audible interference in the co-connected POTs handset, and data transmission performance of the communication device. Audible interference in the co-connected POTs handset can be readily assessed by the user during a POTs session. Data transmission performance of the communication device is monitored by some data communication software (e.g. a web browser) and displayed to the user. In other cases, the user can discern data transmission performance of the communication device by observing the rate at which the data communication software performs transmission rate-dependent functions (e.g. downloading data).

Preferably, the user's selection of one of the preliminarily defined possible values is obtained by means of a software control panel that may be displayed on a display screen. Thus by activating and using the control panel during a POTs session, a user may adjust the power cutback to obtain a suitable level of audio interference.

In an embodiment of the invention, the software control panel includes a slider-control between maximum data performance and maximum audio performance. By means of the slider control, the user can select a value between these maxima. In another embodiment of the invention, the software control panel includes a number of radio buttons, each representing a respective value between maximum data performance and maximum audio performance. In either case, the value that is returned by the control panel is preferably one of a set of predetermined values.

In an embodiment of the invention, the value selected by the user is used to calculate a power cutback parameter that is stored in a memory of the communication device. When an off-hook event is detected, the CPE communications device performs a fast retrain including a line probe to determine interference. Based on the results of the line-probe, the communication device calculates upstream transmit power and a downstream transmit power cut back, based on both the measured interference and the power cutback parameter previously saved in memory. When the user selection indicates a user preference for maximum data transmission performance, the power cutbacks are calculated solely on the basis of the measured interference. Alternatively, when the user selection indicates a user preference for maximum audio performance of the POTs handset, the power cutback is calculated to keep audible interference below a threshold value, and the data transmission rate is determined based on the cut-back transmission power.

### BRIEF DESCRIPTION OF THE DRAWINGS

Further features and advantages of the present invention will become apparent from the following detailed description taken in combination with the appended drawings, in which:

FIG. 1 is a schematic diagram illustrating a communications device in accordance with an embodiment of the present invention, and its connection to an exemplary local access loop having a co-connected POTs handset;

FIGS. 2a-2c illustrate an exemplary control panel for receiving a user selection of discernible attributes, and a scenario for determining data transmission power based on the user selection; and

FIGS. 3a-3c illustrate the control panel of FIG. 2a for receiving a user selection of discernible attributes, and a second scenario for determining data transmission power based on the user selection.

FIGS. 4a-4c illustrate the control panel of FIG. 2a for receiving a user selection of discernible attributes, and a third scenario for determining data transmission power based on the user selection.

It will be noted that throughout the appended drawings, like features are identified by like reference numerals.

### DETAILED DESCRIPTION OF THE PREFERRED EMBODIMENT

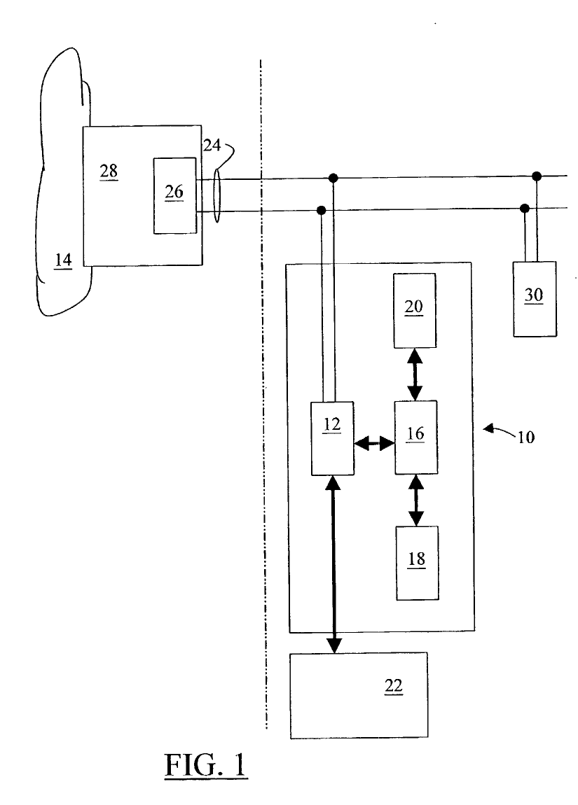

As shown in FIG. 1, a communications device 10 compatible with the present invention and located at a customer premises includes a network interface 12 for interfacing with a network 14; a microprocessor 16 for controlling the operation of the communication device 10; a FLASH memory 18 for storing firmware and operation control parameters; and random access memory (RAM 20) used for storing run-time data, as well as up-stream and down stream communication buffers (not shown). In the illustrated embodiment, the communications device 10 is operatively connected to a host computer 22 via network interface 12. In use, the microprocessor 16 operates in accordance with firmware stored in the FLASH memory 18 to provide the functionality of the communications device 10 (e.g. to transfer information between the host computer 22 and the network 14).

The communications device 10 is operatively connected by a conventional (twisted pair) subscriber loop 24 to a line card 26 located in a central office (CO) 28, which provides access to the network 14 in a conventional manner. Communications sessions can therefore be established between the communications device 10 and other devices connected to the network 14. In FIG. 1, a conventional POTs handset 30 is co-located with the communications device 10, and connected to the subscriber loop 24. Although not shown in the drawing, it should be understood that multiple POTs handsets 30 may be co-located with the communications device 10. Thus the POTs handset 30 is susceptible to audible interference associated with a data transmission power of the communications device 10.

In an embodiment of the invention, the communications device 10 is configured to implement the International Telecommunications Union (ITU) recommendations for splitterless ADSL equipment based on discrete multitone (DMT) technology standards (G.992.2), which is also known as ADSL.Lite. Of course, the communications device may implement some other standard suitable for xDSL communications particularly in a splitterless configuration.

In accordance with the present invention, the microprocessor 16 operates to determine a power cut-back for data transmission on the xDSL channel based on a user-selected value indicative of user-discernible attributes, as discussed below. Under the ADSL.Lite standard an initialization “politeness” power cutback is required for short subscriber loops 24 where the CO and CPE are in relatively close proximity. A cutback of down-stream power (i.e., from Co to subscriber) is required for a subscriber loop 24 having a small power loss over the loop's relatively short length. The cutback is applied during start-up and is calculated by measuring the up-stream power. For every 1 dB less than 6 dB of measured upstream loop loss, the down-stream power is cutback by 2 dB. While a politeness cutback is not currently required in the up-stream direction (i.e. from subscriber to CO), it is an anticipated requirement in future versions of the standard.

Further under the ADSL.Lite standard (ITU. G.992.2), a linearity cut-back is aLlowed based on a line probe test initiated by the communications device 10, as is understood by those skilled in the art. A further power reduction may be necessary when the POTs is in use (i.e. off-hook) to inhibit the mixing of out of band power into the POTs band by a non-linearity in the handset. The susceptibility to distortion is handset dependent. Audible distortion at the handset may or may not be measured by line probing by the CPE. Thus, additional power cutback calculations are required.

When the communications device 10 detects an off-hook event, it applies a cutback to reduce the likelihood of audible interference into the handset 30. The amount of off-hook cutback for this feature is determined either by a default setting or by a user selected value. User selection permits the subscriber to control the level of interference in a more subjective manner. Thus, those with less susceptible POTs equipment, or those having a higher tolerance for audible interference during the off-hook event can obtain a modem's full potential data rate. Of course, a final cutback applied takes into consideration other requirements such as politeness, linearity and maintaining the connection.

A default off-hook power cutback parameter may be initialized in a variety of ways. For example, a factory setting may be used. The value may be chosen to favor maximum data performance, and thus not apply any cutback. Such a choice will maximize the likelihood of maintaining upstream connection between the CO and CPE but will also maximize the probability of audible noise. The default may apply an arbitrary estimate of power cutback based on an estimate of average cutback requirements for a particular market. However, applying an average cutback may be too severe to permit long loops to maintain upstream connectivity.

Alternately and preferably, a calculated power value that maintains a predefined minimum data throughput may be used as an initial or default value. Thus the default value may be determined as a function of loop attenuation and noise characteristics at the time of calculation. Beneficially under this scenario, upon initial use of the communications device 10, both the POTs handset 30 and communications device 10 are maximally likely to work without splitters. Thus, a customer can initially install the communications device and call out for assistance service, if necessary, for initial use. However, when the default power value is used while the co-connected POTs handset 30 is off-hook, the off-hook data performance is reduced to a lowest acceptable rate, penalizing those with good handsets. The closer together is the CO and CPE, the more cutback will be applied and the likelihood of audible interference is less. On long subscriber loops, the incidence of unprotected POTs handsets experiencing interference will be higher. It is likely that splitters will be necessary on some long loops under any power cutback scenario, because a connection with the CO could not be maintained if any power cutback were attempted.

To implement the calculated default option thus described, the cutback is calculated based on providing a target minimum data transfer rate upstream. Based on the on-hook data rate for the line conditions then existing (as determined, in part, due to politeness and line probing power cutback) and assuming no change in the noise level resulting from the transition to off-hook, the communications device may calculate upstream transmit power(P_{Target}) that would achieve the Target rate. Should the current on-hook data rate be less than the Target rate, P_{Target} may be set to P_{OH}, as defined below, to increase the likelihood of maintaining existing performance. Given that the tested maximum power to achieve acceptable audible performance for tested telephones is P_{US}_{_{—}}_{Audable}, as defined below, the default upstream off-hook power is calculated as P_{US}_{_{—}}_{TX}_{_{—}}_{ADJ}=MAX (P_{US}_{_{—}}_{Audable}, P_{Target}) . Thus on short loops, an upstream data rate greater than the target minimum may be obtained.

It is preferable that the default cutback setting alone should not cause a loss of data transmission connectivity between the CPE and CO. However, such may occur if the line noise changes significantly in the off-hook condition. In such a case and even if the result thereof sets P_{Target}=P_{OH}, the communications device may perform a retrain, recalculating line probe based cutbacks etc. to reconnect CO and CPE transmissions while ignoring the default cutback if the subscriber has not entered a user selectable power cutback as described below.

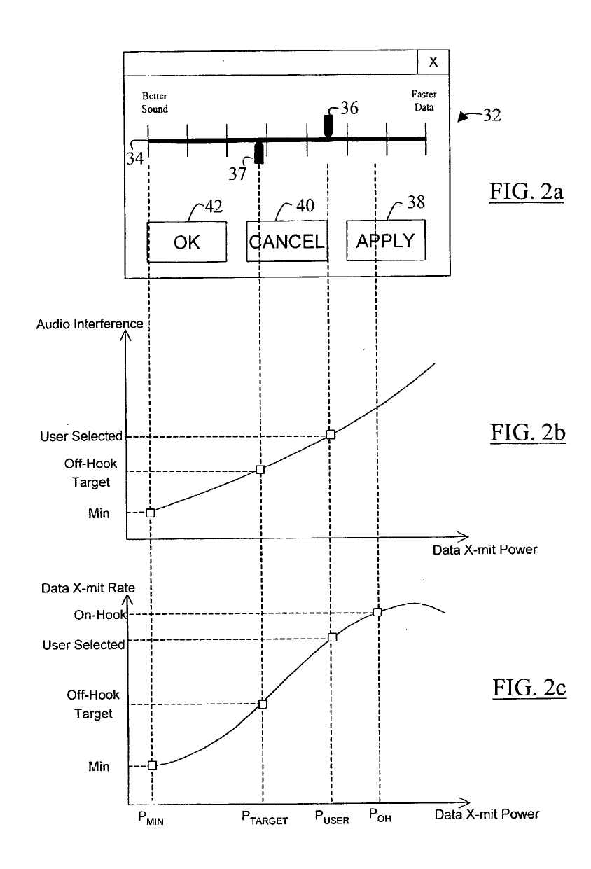

According to the invention, a user selectable power cutback is also provided to subjectively override the default power setting. As shown in FIG. 2a, user selections can be obtained using a control panel 32 displayed on a monitor (not shown) of the host PC 12. In the illustrated embodiment, the control panel 32 includes a linear scale 34 having a user-controllable slider icon 36 which a user can manipulate via a pointer device (not shown) connected to the PC 12 (FIG. 1) to indicate a relative priority between two user-discernible attributes. The control panel 32 also includes: an “Apply” icon 38 enabling a user to accept a current selection (as indicated by the position of the slider icon 36) without closing the control panel 32; an “OK” icon 42 enabling a user to accept a current selection and close the control panel 32; and a “Cancel” icon 40 enabling the user to close the control panel 32 and revert to a previously accepted selection. The power setting may be illustrated to the user on the control panel such as by an icon 37 positioned appropriately on the slider. The initial position of the slider icon 36 may be mapped to the default power setting position.

As shown in FIG. 2a, the user discernible attributes are data transmission speed which may be discerned by the user by an up-load and download performance of a communications application—e.g. a web browser; and audio quality of a co-connected telephone handset which may be directly discerned by the user during use of the POTs handset 30. Other user-discernible attributes may be used, as desired, either in place of, or in addition to, those of the illustrated embodiment. Similarly, other means of obtaining user selected preferences may be used instead of the linear scale 34 and slider icon 36, such as, for example, radio buttons.

A scale that relates to a single discernible characteristic such as upstream data rate may be employed but is not preferred. Some rates will not be achievable for users on a given subscriber loop and may lead to unfulfilled expectations. Moreover, POTs noise associated with the selection may change with noise conditions on the loop.

Preferably the scale 34 is partitioned in increments (having no specific units) which correspond to constant power on the subscriber loop 14 at the CPE. Thus, the data rate may vary depending on the level of other interferors such as crosstalkers but the audible interference in a particular handset should remain constant for a user selected setting. A preferred setting scale may be represented by the limits Maximum Off-hook Data Rate representing a null loop maximum receive power and therefore no power reduction, and Minimum Telephone Noise representing maximum power cutback required to eliminate audible noise as tested and including an additional amount for poorer performing telephone sets than were tested. The scale may be partitioned to provide appropriate resolution.

FIGS. 2a2c illustrate a method by which the user selection set and accepted by the user may be used to determine a power cutback during oft-hook events. FIG. 2b is a graph showing an exemplary relationship between audible interference and data transmission power of the communication device 10. FIG. 2c is a graph showing an exemplary relationship between data transmission rate and data transmission power of the communication device 10. The terms P_{MIN}, P_{TARGET}, P_{USER} and P_{OH} illustrate power values associated with the following conditions:

| | |
|---|---|
| P_{MIN} | Minimum power required to maintain connectivity |
| | between CO and CPE |
| P_{Target} | Power required to provide the Target minimum rate |
| P_{USER} | Power level selected by the user for off-hook |
| | transmissions |
| P_{OH} | Power level for on-hook transmissions given |
| | subscriber loop and equipment conditions |

It should be noted that the illustrated relationships shown in FIGS. 2b and 2c are arbitrary. Actual relationships will be a function of equipment performance (of both the POTs handset 30 and the communication device 10); length and quality of the local subscriber loop 24; and user perception. However, as illustrated in FIG. 2b audible interference as perceived by the user will normally increase with increasing data transmission power. Similarly, the data transmission rate of the communication device 10 will normally increase with increasing data transmission power. Thus while the user makes a selection of a priority between user discernible attributes (data transmission performance and POTs audio quality), the values returned by the control panel 32 to indicate the user's preference can conveniently be related to data transmission power (which is not directly discernible to the user).

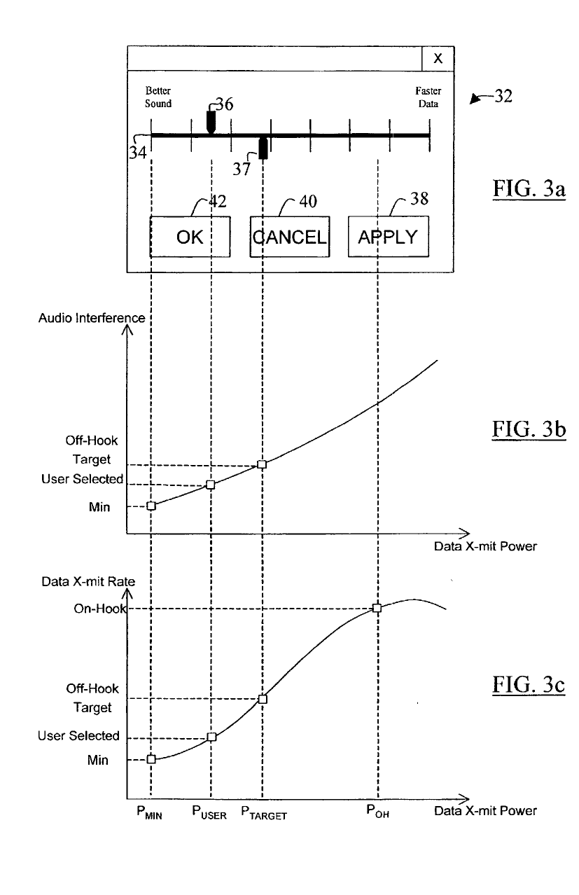

A user preference placing a higher priority on data performance (as indicated by the user-selected location of the slider icon 36) implies the user's willingness to tolerate comparatively higher audible interference in order to retain high data transmission rates during off-hook events, or that his equipment is less susceptible due to its design or the presence of inline filters. This in turn implies that the communications device 10 may use a comparatively small power cutback. Conversely, as illustrated in FIGS. 3a-3c, user preference placing a higher priority on audio quality implies the user's willingness to tolerate comparatively poor data performance in order to obtain low audio interference when using their POTs handset 30. This further implies that the communications device 10 should use a comparatively larger power cutback.

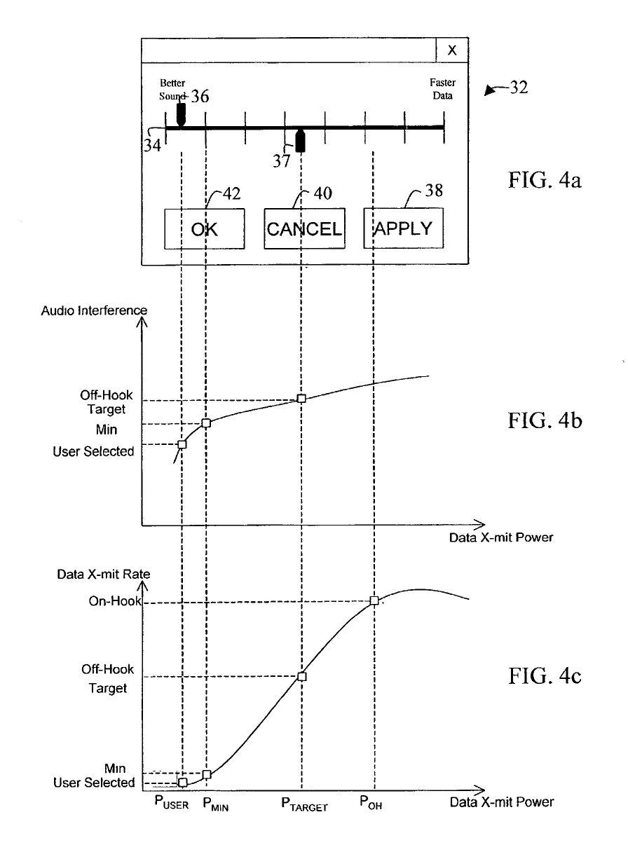

POTs equipment and subscriber loop conditions may require a user to reduce power to an extent that data transmissions are terminated while off-hook. FIGS. 4a-4c illustrate a user selection that reduces power sufficiently to halt data transmissions in favour of improved audio performance while off-hook.

In accordance with the invention, a user is directed to adjust the scale 34 with the slider 36 while making a telephone call with the communications device 10 in an active state. Of course, a selection may be made prior to a telephone call for use during a call. Audible interference may vary with different telephone sets and different combinations of telephone sets. Moreover, higher data rates may be achieved by using splitters/filters. With respect to splitter installation, an off-hook transition should not effect the communications device 10, and maximum data rate otherwise allowable will automatically occur. In the case of in-line filter operation, it may be necessary to user select cutback as the degree of filter protection is limited by the need to allow microfilters on multiple extensions and still not impact POTs performance.

The control panel 32 is used to determine off-hook power cutback in accordance with the following steps, and as illustrated in FIGS. 2a-2c:

During a telephone call (i.e. POTs handset 30 is off-hook) the user opens the control panel 32;

The user then moves the slider icon 36 to a desired position, and clicks the “Apply” icon 38 to accept the user's selection while keeping the control panel 32 open;

When the “Apply” icon 38 is clicked, the control panel 32 returns a scale setting value P_{USER} to the microprocessor 16 indicative of the accepted position of the slider icon 36;

Following user selection of the power value P_{USER} as described above, the microprocessor 16 saves the parameter in the FLASH memory 18 for use during future off-hook events, and then controls the network interface 12 to transmit data at the new transmission power setting as described more fully below;

When the new transmission power setting is asserted, the CPE and the CO will enter a full retrain sequence, which can take up to 5-20 seconds;

The user can then determine, based on the resulting audible level of interference in the POTs handset 30, whether the selection (based on the location of the slider icon 36 on the control panel 32) is satisfactory. If the user is satisfied with the level of audible interference in the POTs handset 30 as balanced by the resulting data transmission performance, the user may close the control panel 32. Otherwise, the user can move the slider icon 36 to a new position and click the “Apply” icon 38 again to repeat the above steps;

Alternatively, the CPE can be programmed to assert the new power level directly in response to movement of the slider icon. Although, synchronization with the CPE would be lost, the user could judge the effects of the adjustment immediately without writing for a ful retrain, as described above. After the new level is selected, the full retrain would ensue and the CPE would re-synchronize with the CO, as described above.

Once the value of P_{USER} has been set and applied, if the communications device is in an off-hook state, a fast retrain event will occur to permit the microprocessor 16 to recalculate and signal the appropriate CO and CPE cutbacks and thus permit the user to hear the results of the setting at the POTs handset 30. If the communications device 10 is on-hook, the fast retrain is performed at the next off-hook event using the saved selection.

It is necessary to apportion power cutback between the CO and CPE. For linearity (as determined by line probing) and user selected off-hook power, the total upstream and downstream power at the communications device 10 is a fixed quantity. An appropriate cutback must be distributed between the CO and CPE to achieve this value. This assignment of cutback is determined by the CPE and the required apportioned CO cutback is signaled up to the CO. G.Lite protocol provides that up to 62 dB of cutback can be requested, in 2 dB increments. The CPE (i.e. microprocessor 16) calculates the power reduction apportionment from its knowledge of linearity, off-hook requirements (default and user selected values) and the power of the received downstream signal at the current known downstream cutback. The following variables are useful in determining the cutback apportionment:

| | |
|---|---|
| P_{Audable} | Maximum Power that will not cause audible |
| | noise in POTs handset (determined by |
| | laboratory measurements of many handsets); |
| P_{US}_{_{—}}_{Audable} | Portion of P_{Audable} allocated to upstream |
| | transmission; |
| P_{DS}_{_{—}}_{Audable} | Portion of P_{Audable} at the CPE allocated to |
| | downstream transmission; |
| P_{DS}_{_{—}}ᵣₓ | Downstream power present at CPE; |
| P_{DS}_{_{—}}ᵣₓ_{_{—}}_{ADJ} | Computed adjusted downstream power to be |
| | applied at CPE; |
| P_{DS}_{_{—}}ₚₒₗᵢₜₑ | Downstream power present at CPE after |
| | politeness cutback applied; |
| P_{US}_{_{—}}_{Tx} | Upstream power present at CPE; |
| P_{US}_{_{—}}_{Tx}_{_{—}}_{ADJ} | Comuted upstream power to be applied at |
| | the CPE; |
| P_{CPE}_{_{—}}_{TOT} | Total power present at the CPE = P_{DSrx} + |
| | P_{US}_{_{—}}_{Tx}; |
| P_{CPE}_{_{—}}_{Lin} | Maximum power allowed at CPE such that |
| | maximum downstream data transmission rate |
| | is maintained |
| P_{US}_{_{—}}_{Lin} | Maximum upstream power allocated from |
| | P_{CPE}_{_{—}}_{Lin}; |
| P_{DS}_{_{—}}_{Lin} | Maximum downstream power at the CPE |
| | allocated from P_{CPE}_{_{—}}_{Lin}; |
| P_{TARGET} | Total power present at CPE required to |
| | maintain the target minimum acceptable |
| | data transmission rate as calculated |
| | during on-hook based on then existing |
| | conditions. If the minimum upstream rate |
| | is not achieved for the existing |
| | conditions, P_{TARGET} is equivalent to full |
| | power; |
| P_{US}_{_{—}}_{Target} | Upstream power present at CPE required to |
| | maintain the target minimum acceptable |
| | data transmission rate as calculated |
| | during on-hook, based on then existing |
| | conditions. If the minimum upstream rate |
| | is not achieved for the existing |
| | conditions, P_{US}_{_{—}}_{Target} is equivalent to full |
| | upstream power; |
| P_{DS}_{_{—}}_{Target} | Downstream power present at CPE required |
| | to maintain the target minimum acceptable |
| | data transmission rate as calculated |
| | during on-hook based on then existing |
| | conditions. If the minimum rate is not |
| | achieved for the existing conditions, |
| | P_{DS}_{_{—}}_{Target} is equivalent to full downstream |
| | power; |
| P_{CPE}_{_{—}}_{Phone} | Total power associated with user selected |
| | level of audible handset noise; |
| P_{US}_{_{—}}_{Phone} | The portion of P_{CPE}_{_{—}}_{Phone} allocated to |
| | upstream transmission to achieve the user |
| | selected level of audible handset noise; |
| P_{DS}_{_{—}}_{Phone} | The portion of P_{CPE}_{_{—}}_{Phone} allocated to |
| | downstream transmission at the CPE to |
| | achieve the user selected level of audible |
| | handset noise; and |
| CUTBACK_{DS} | The additional cutback, if any, that |
| | should be applied by the CO on top of any |
| | politeness cutback already applied. |

A basis for dividing the power between the US and DS signals at the CPE is shown below in pseudo-code. The symbol X may be replaced by LIN for the linearity calculations, Phone for handset noise calculations, Audible for the default calculation of audible noise, and Target for the calculation of maintaining the target data rate. Basically, the following equation must be satisfied for a given desired total power value P_{CPE}_{_{—}}_{X}:

P_{CPE}_{_{—}}_{X}>=10 log(10ˆ ((P_{DSrx}_{_{—}}_{X})/10))+10ˆ ((P_{US}_{_{—}}_{X})/10) (1)

Power values P_{DSrx}_{X} and P_{US}_{_{—}}_{X} must be determined by cutting back available downstream power (P_{DS}_{_{—}}ₚₒₗᵢₜₑₙₑₛₛ) and upstream power (P_{US}_{_{—}}_{Tx}). Before additional cutback is applied, the upstream transmission power value is always the largest component of the total power value at the CPE, as no upstream cutback is currently required by the standard. In order to satisfy the general equation, P_{US}_{_{—}}_{X} is cutback first in 2 dB increments until equation (1) is satisfied or until P_{US}_{_{—}}_{X} is less than or equal to P_{DSrx}_{_{—}}_{X}. Then each of P_{US}_{_{—}}_{X} and P_{DSrx}_{_{—}}_{X} is reduced in alternating 2 dB steps with P_{US}_{_{—}}_{X} receiving the initial reduction according to the following pseudo-code:

P_{DSrs}_{_{—}}_{X}=measured P_{DSrx}_{_{—}}ₚₒₗᵢₜₑ; (i.e. a downstream power baseline given politeness cutback)

P_{US}_{_{—}}_{X}=available P_{US}_{_{—}}_{Tx}

Increase S from 0 until:

P_{CPE}_{_{—}}_{X}>=10 log(10ˆ ((P_{DSrx}_{_{—}}_{X})/₁₀+10ˆ ((P_{US}_{_{—}}_{X}−2S)/₁₀) (a)

OR

(P_{US}_{_{—}}_{X}−2S)<=P_{DSrx}_{_{—}}_{X}

If equation (a) is not satisfied: Then increase T from 1 until:

P_{CPE}_{_{—}}_{X}>=10 log(10ˆ ((P_{DSrx}_{_{—}}_{X}−2(T−1)/₁₀)+10ˆ (P_{US}_{_{—}}_{X}−2S−2T)/₁₀) (b)

OR

P_{CPE}_{_{—}}_{X}>=10 log((10ˆ (P_{USrx}_{_{—}}_{X}−2T)/₁₀+10ˆ ((P_{US}_{_{—}}_{X}−2S−2T)/₁₀) (c)

Once one of equations (a), (b), or (c ) are satisfied and depending on which is satisfied, then desired P_{US}_{_{—}}_{X} and P_{DSrx}_{_{—}}_{X} are calculated as:

$$\begin{matrix}{P}_{US\_X} = ( {P}_{US\_X} - 2 S ) ; for satisfied equation ( a ) OR \\ = ( {P}_{US\_X} - 2 S - 2 T ) ; for satisfied equation ( b ) which \\ can only be satisfied when T is an odd number ; OR \\ = ( {P}_{US\_X} - 2 S - T ) ; for satisfied equation ( c ) , which \\ can only be satisfied when T is an even number . \\ {P}_{DSrx\_X} = 0 ; for satisfied equation ( a ) OR \\ = ( {P}_{DSrx\_X} - 2 ( T - 1 ) ) ; for equation ( b ) OR \\ = ( {P}_{DSrx\_X} - T ) ; for equation ( b )\end{matrix}$$

CUTBACK_{DS}_{_{—}}_{X}=0, 2(T−1) or 2T; depending whether equations (a), (b), or (c) are satisfied. (i.e. CUTBACK_{DS}_{_{—}}_{X}=P_{DSrx}_{_{—}}ₚₒₗᵢₜₑ−P_{DSrx}_{_{—}}_{X})

CUTBACK_{US}_{_{—}}_{X}=2S or 2S−2T depending on whether equation (a) is satisfied

Given the basic equations, appropriate upstream and downstream power and cutbacks may be determined for on-hook and off-hook states according to the following methods:

Off-Hook calculation of upstream and downstream transmit
powers with default off-hook setting

| | | |
|---|---|---|
| Measure: | Downstream received | |
| | power (P_{DS}_{_{—}}ᵣₓ) | |
| | Line Probe | line probes are proprietary |
| | | and many line probe models |
| | | are known; |
| Calculate: | P_{CPE}_{_{—}}_{Lin} | using any one of many known |
| | | methods; |
| | P_{DS}_{_{—}}_{Polite} | as described above; |
| | P_{US}_{_{—}}_{Lin and} | using any one of many |
| | P_{rxDS}_{_{—}}_{Lin} | known methods; |
| | P_{US}_{_{—}}_{target and} | extrapolate for |
| | P_{DS}_{_{—}}_{target} | desired target |
| | | minimum data rate |
| | | given current data |
| | | rate and power |
| | | values, plus default |
| | | backoff. |

P_{US}_{_{—}}_{TX}_{_{—}}_{ADJ} = MAX (P_{US}_{_{—}}_{minrate,} P_{US}_{_{—}}_{audible})
and,
P_{DS}_{_{—}}ᵣₓ_{_{—}}_{ADJ} = MIN ( (P_{rxDS}_{_{—}}_{Lin}, P_{rxDS}_{_{—}}ₚₒₗᵢₜₑ, MAX (P_{DS}_{_{—}}_{minrate,}
P_{DS}_{_{—}}_{audible}) )

| | |
|---|---|
| Apply: | P_{US}_{_{—}}_{TX}_{_{—}}_{ADJ} |
| | CUTBACK_{DS} = |
| | P_{rxDS}_{_{—}}ₚₒₗᵢₜₑ − P_{DS}_{_{—}}ᵣₓ_{_{—}}_{ADJ} |

Off-Hook calculation of upstream and downstream transmit
powers with User selected off-hook setting

| | | |
|---|---|---|
| Measure: | Downstream | |
| | received power | |
| | Line Probe | line probes are proprietary |
| | | and many line probe models |
| | | are known; |
| Calculate: | P_{CPE}_{_{—}}_{Lin} | using any one of many known |
| | | methods; |
| | P_{DS}_{_{—}}_{Polite} | as described above; |
| | P_{US}_{_{—}}_{Lin} and | calculate linearity |
| | P_{rxDS}_{_{—}}_{Lin} | using any one of many |
| | | known methods; |
| | P_{US}_{_{—}}_{target} and | extrapolate for |
| | P_{DS}_{_{—}}_{target} | desired target |
| | | minimum data rate |
| | | given current data |
| | | rate and power |
| | | values, plus default |
| | | backoff. |
| | P_{US}_{_{—}}ₚₕₒₙₑ | per user |
| | and P_{DS}_{_{—}}ₚₕₒₙₑ | specification. |

P_{DS}_{_{—}}ᵣₓ_{_{—}}_{ADJ} = MIN(P_{rxDS}_{_{—}}_{Lin}, P_{rxDS}_{_{—}}ₚₒₗᵢₜₑₙₑₛₛ, P_{rxDS}_{_{—}}ₚₕₒₙₑ);
P_{US}_{_{—}}_{TX}_{_{—}}_{ADJ} = MIN(P_{US}_{_{—}}_{Lin}, MAX(P_{US}_{_{—}}ₘᵢₙᵣₐₜₑ, P_{US}_{_{—phone}}))

| | |
|---|---|
| Apply: | P_{US}_{_{—}}_{TX}_{_{—}}_{ADJ} |
| | CUTBACK_{DS} = |
| | P_{rxDS}_{_{—}}ₚₒₗᵢₜₑ − P_{DS}_{_{—}}ᵣₓ_{_{—}}_{ADJ} |

The invention therefore provides a method and apparatus that permits a user to selectively control the transmit power of DSL equipment to achieve a personal comfort level with respect to interference on the POTs channel of a subscriber line. This ensures maximum data performance, given user telephone equipment and tolerance to audio interference. As will he understood by those skilled in the art, although the ADSL.Lite standard does not presently require power in the upstream direction, the formulas set forth above can readily be reworked to determine upstream power settings with this additional contstraint.

The embodiment(s) of the invention described above is (are) intended to be exemplary only. The scope of the invention is therefore intended to be limited solely by the scope of the appended claims.

We claim:

1. A method of regulating data channel transmission power of a data communications device during “off-hook” events of a POTs channel handset co-connected with the data communications device, the method comprising steps of:
a) determining a value of one or more user control indicators indicative of user-discernible performance qualities;
b) calculating a data channel transmission power level using the value of the one or more user control indicators;
c) saving the calculated power level in a memory of the communication device; and
d) setting the data channel transmission power in response to the calculated power level during an off-hook event associated with POTs channel handset.

2. The method as claimed in claim 1 wherein the step of calculating comprises calculating an upstream power reduction value and a downstream power reduction value.

3. The method as claimed in claim 1 wherein the step of calculating further comprises caculating a downstream power reduction value.

4. The method as claimed in claim 1 wherein a step of setting includes a step of signaling the downstream power value to a central office with which the data communications device is in communication.

5. The method as claimed in claim 1 further including a step of determining a default off-hook power level and wherein the step of calculating is responsive to the default off-hook power level.

6. The method as claimed in claim 1, wherein the user-discernible performance qualities include at least one of: data transmission speed of the communication device; audible interference in the POTs channel handset; and a user prioritization between data channel and POTs channel performance.

7. The method as claimed in claim 1, wherein the step of determining a value includes steps of:
a) providing to a user a means for inputting a selected value of the user control indicators; and
b) receiving the user's selected value.

8. The method as claimed in claim 4, wherein the step of receiving is performed during an off-hook event of the POTs channel handset.

9. A method of controlling audible interference in a POTs channel handset induced by data channel transmission power of a co-connected xDSL communications device, the method comprising the steps of;
a) defining at least one user-selectable attribute indicative of at least one user-discernible performance quality;
b) monitoring the at least one attribute for a change in state;
c) calculating a level of data transmission power on the basis of the at least one attribute;
d) storing the calculated power level in a memory of the communication device; and
e) during an off-hook event of the POTs handset, controlling the data channel transmission power of the communications device in accordance with the saved power level.

10. The method as claimed in claim 8 wherein the step of calculating comprises calculating an upstream power reduction level.

11. The method as claimed in claim 10 wherein the step of calculating further comprises a step of calculating a downstream power reduction level.

12. The method as claimed in claim 9 wherein the step of controlling further includes a step of signaling the downstream power value to a central office with which the data communications device is in communication.

13. The method as claimed in claim 9, wherein the user-discernible performance quality includes at least one of: data transmission speed of the communication device; audible interference in the POTs channel handset; and a user prioritization between data channel and POTs channel performance.

14. The method as claimed in claim 9, wherein the step of monitoring includes steps of:
a) providing an interface to permit a user to input a selected value for the at least one user-selected attribute; and
b) receiving the user's selected value.

15. The method as claimed in claim 14, wherein the step of receiving is performed during an off-hook event of the POTs handset.

16. The method as claimed in claim 14, wherein the step of providing an interface includes a step of presenting to the user a default value for the user-selected attribute and the step of calculating is responsive to the default value.

17. A computer program for controlling audible interference in a co-connected POTs channel handset induced by data channel transmission power utilized by customer premises equipment (CPE) for digital subscriber line (DSL), comprising:
a) instructions for generating and displaying an interface for receiving at least one user-selectable attribute indicative of at least one user-discernible performance quality;
b) instructions for calculating a level of data transmission power on the basis of the at least one attribute;
c) instructions for storing the calculated power level; and
d) instructions for detecting an off-hook event of the POTs handset and, in response to detecting an off-hook event, for controlling the data channel transmission power of the communications device in accordance with the saved power level.

18. The computer program as claimed in claim 17 wherein the program further calculates an upstream power reduction level.

19. The computer program as claimed in claim 18 wherein the program further calculates a downstream power reduction level.

20. The computer program as claimed in claim 18 further including instructions to operate the CPE to signal the downstream power value to a central office with which the data communications device is in communication.

21. The program as claimed in claim 17, wherein the user-discernible performance quality includes at least one of: data transmission speed of the communication device; audible interference in the POTs channel handset; and a user prioritization between data channel and POTs channel performance.

22. The program as claimed in claim 17, wherein the program receives the user-selected attribute in response to a user input.

23. The program as claimed in claim 22, wherein the program retrieves the attribute from storage during each off-hook event of the POTs handset.

24. The program as claimed in claim 17, further comprising:
a) instructions for calculating a default power level for controlling audible interference in the POTs channel;
b) instructions for storing the default power level in a memory;
c) instructions for communicating the default power level to the CPE; and
d) during an off-hook event and in the absence of a user selected attribute, instructions for controlling the data channel transmission power in accordance with the default power level.

25. A method of regulating data channel transmission power of a data communications device during “off-hook” events of a POTs channel handset co-connected with the data communications device, the method comprising a steps of:
a) calculating default data channel transmission power levels using parameters based on a target minimum data rate, a default audible noise protection level, and linearity measures obtained using a line probe;
b) saving the calculated data default data channel transmission power levels in a memory; and
c) applying the default data channel transmission power levels in the absence of a user preference indication that overrides the default.
